(19) United States
(12) Patent Application Publication
(10) Pub. No.: US 2002/0107868 A1
(43) Pub. Date: Aug. 8, 2002

(54) Collection system for RAM data

(76) Inventors: Mark Childs, Canton, GA (US); Mark A. Cournoyer, Marietta, GA (US); Patrick J. Hamilton, Marietta, GA (US); Steven L. Hartman, Delmar, NY (US); Kent S. Prieskorn, Smyrna, GA (US); Anthony J.A. San Nicolas, Kennesaw, GA (US); Suresh Sharma, Marietta, GA (US); Rohan Kelkar, Marietta, GA (US)

Correspondence Address: PERKINS COIE LLP, PATENT-SEA, P.O. BOX 1247, SEATTLE, WA, 98111-1247, US

(21) Appl. No.: 09/729,998

(22) Filed: Dec. 4, 2000

(51) Int. Cl. G06F 7/00

(52) U.S. Cl. 707/104.1

(57) ABSTRACT

A method and system for collecting RAM data from distributed locations is provided. The client-side component includes a collection component that provides various display pages for the entry of RAM data. After a user collects the RAM data, the user inputs the data using the collection component. Periodically, the client-side component transmits the collected RAM data to the server computer. In one embodiment, the collection system sends the RAM data from the client computers to the server computer via electronic mail messages. When the server-side component receives the RAM data, it validates the RAM data and, if valid, automatically stores the RAM data in a database.

### TECHNICAL FIELD

The described technology relates generally to the collection of RAM data and more particularly to the collection of RAM data from remote locations.

### BACKGROUND

The collection of reliability and maintenance data (“RAM data”) is especially important for monitoring the performance of various plants, such as power plants and manufacturing plants. These plants may outsource the maintenance of the plant equipment to a maintenance organization that is responsible for the maintenance of all the equipment of the plant. The contract between the plant operators and the maintenance organization may specify minimum performance requirements of the plant. For example, a contract may require that certain equipment be up and running a certain percentage of the time or that the equipment be operating at a certain efficiency. If the equipment does not meet the minimum performance requirements, then the maintenance organization may be penalized. In contrast, if the equipment exceeds the minimum performance requirements, the maintenance organization may receive a bonus. It is important for a maintenance organization to collect reliable RAM data in a timely fashion so that it can evaluate whether the minimum performance requirement will be met and take corrective measures as appropriate. It is also important for a maintenance organization to aggregate the RAM data from various plants so that it has a global view of the performance of the plants that it services. This global view may allow the maintenance organization to take proactive measures at one plant based on RAM data received from another plant.

The plants serviced by a maintenance organization may be located throughout the world. For example, a maintenance organization may service power plants in Asia, Europe, North America, South America, and so on. Traditionally, maintenance organizations have collected RAM data from such diverse locations in a variety of ways because the modes of communications may be relatively primitive at remote locations. The RAM data at a plant may be collected and then sent by special courier or postal courier to the headquarters of the maintenance organization. Alternatively, the RAM data may be provided by placing a telephone call to a representative of the maintenance organization. The maintenance organization then manually enters the RAM data into a database. There are difficulties associated with these ways of collecting RAM data. First, when a courier is used from a plant at a remote location, it may take several days for the RAM data to arrive at the headquarters. Second, the use of the telephone results in many error as a result of misunderstandings between the parties and incorrect transcriptions. Third, errors in the RAM data that require correction before the RAM data can be used by the maintenance organization occur often. Subsequent communications either via courier or telephone that is needed to correct the errors that tend to be time-consuming and error prone. Fourth, errors may occur as the RAM data is input into the database of the maintenance organization. In addition, the telephone services, courier services, and other electronic and nonelectronic means for communicating with remote locations may be slow and unreliable.

It would be desirable to have a technique for collecting RAM data from remote locations that would help automate the collection process, facilitate the correcting of errors, and result in a more timely collection of reliable RAM data.

### BRIEF DESCRIPTION OF THE DRIVES

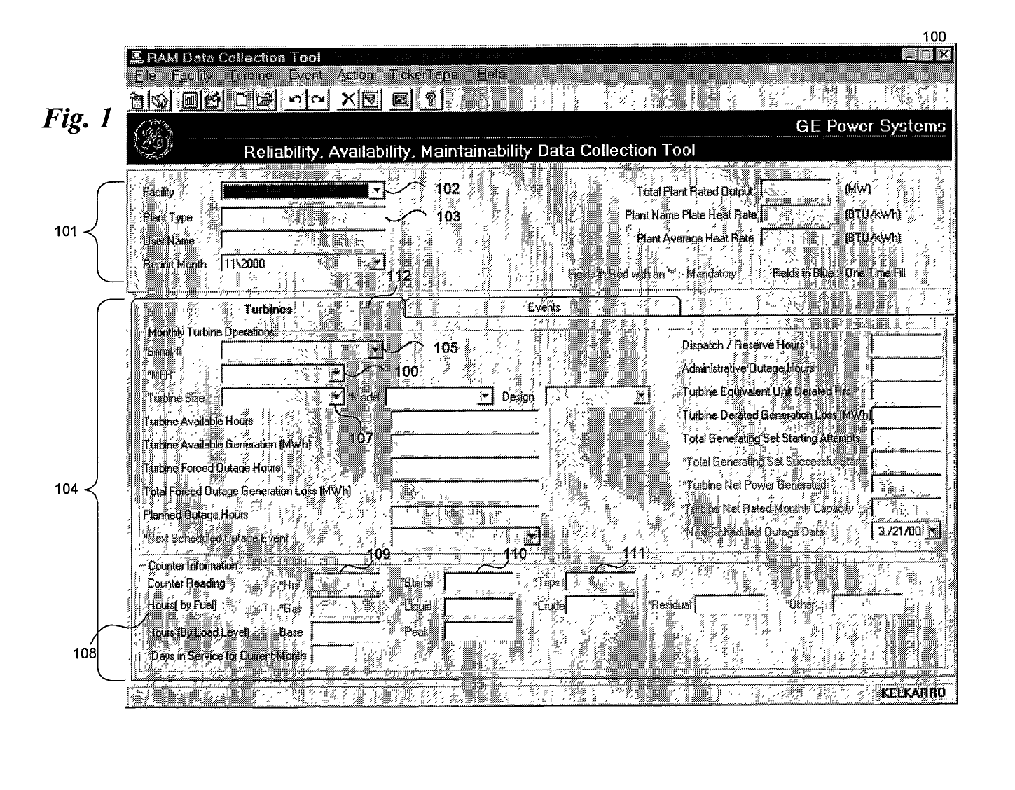

FIG. 1 illustrates a display page of the client-side component for collecting information relating to a power plant with one or more turbines.

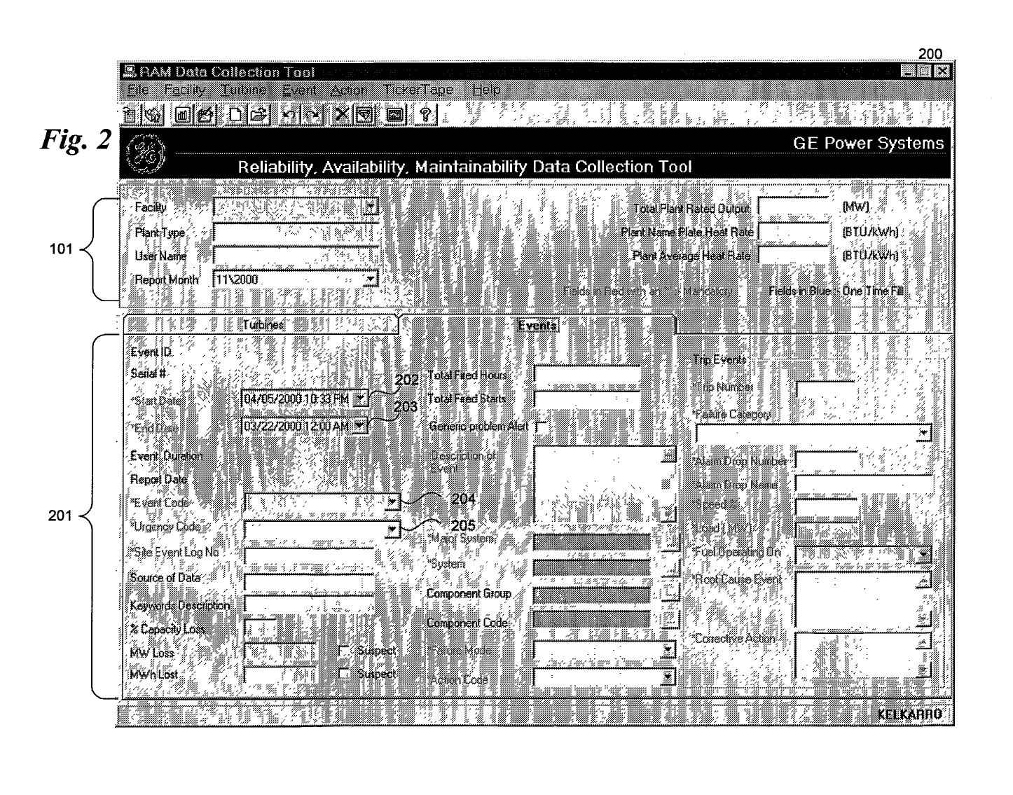

FIG. 2 illustrates the display page of the client-side component for collecting information relating to events of a turbine.

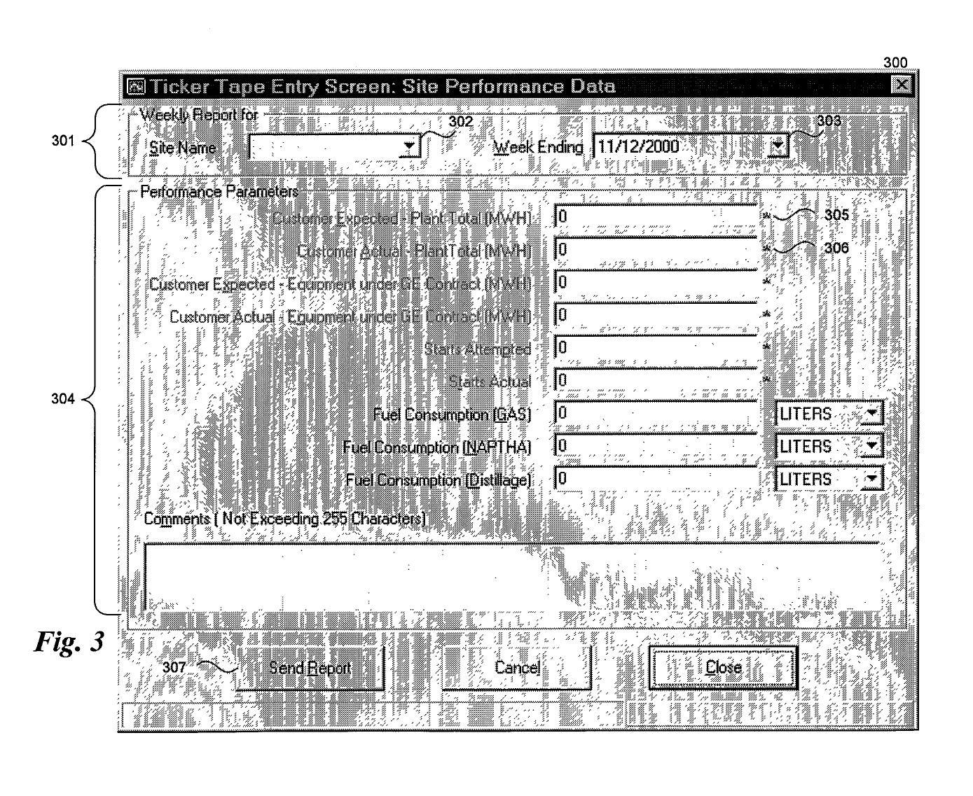

FIG. 3 illustrates a display page of the client-side component for collecting high-level performance information.

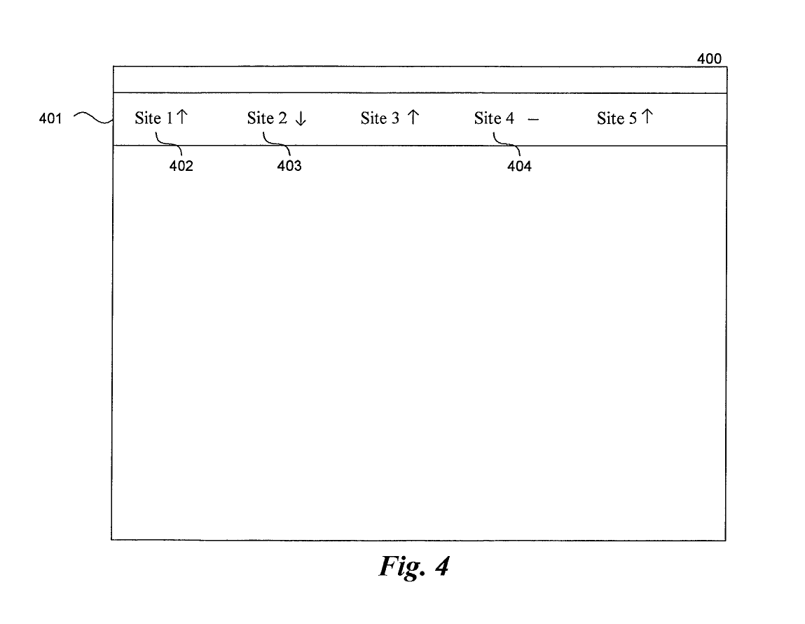

FIG. 4 illustrates a display page display the high-level performance data. Display page 400 includes any ticker tape area 401.

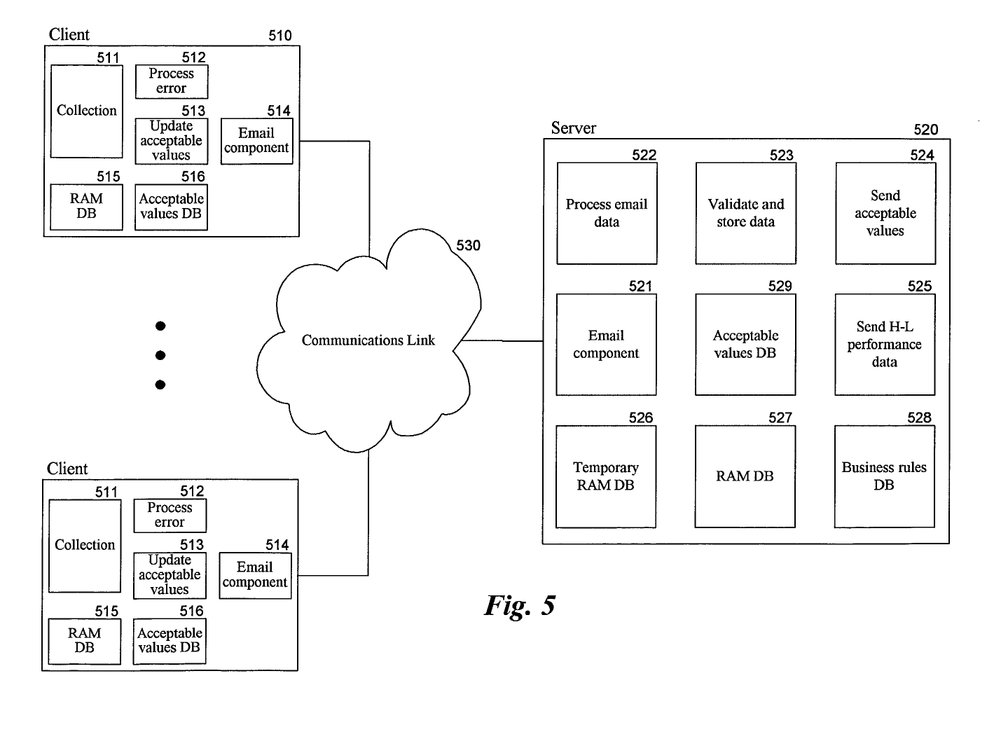

FIG. 5 is a block diagram illustrating the components of the collection system in one embodiment.

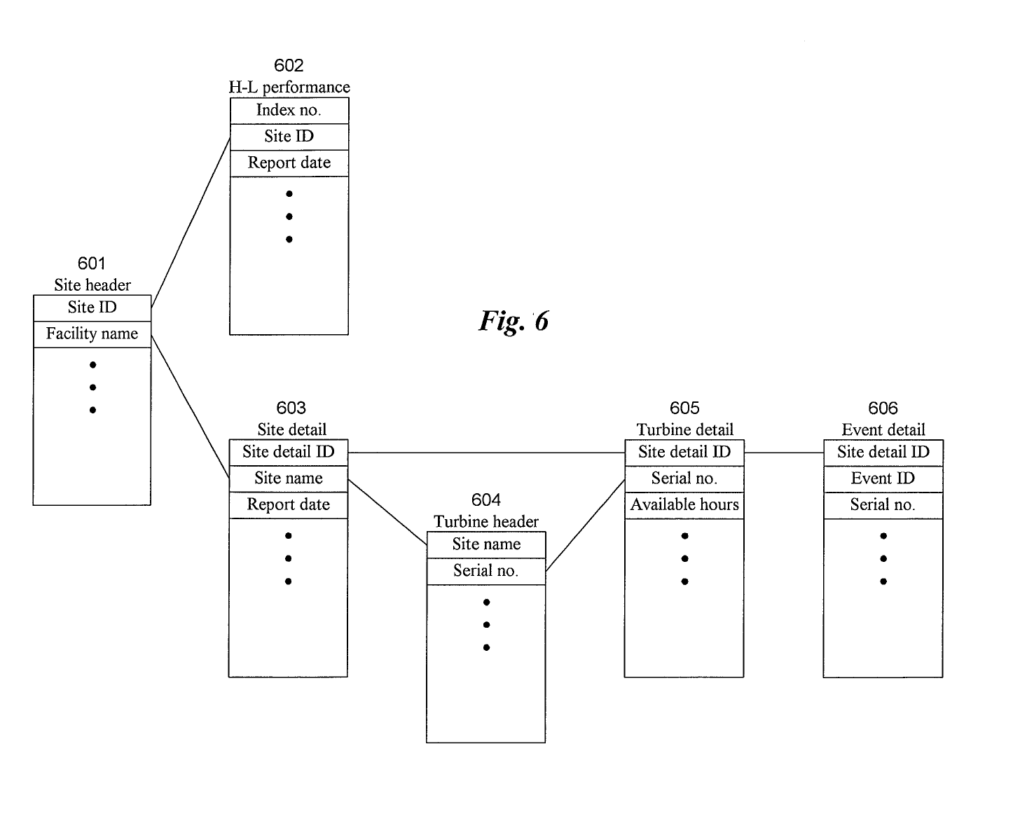

FIG. 6 is a block diagram illustrating the structure of the RAM-related databases.

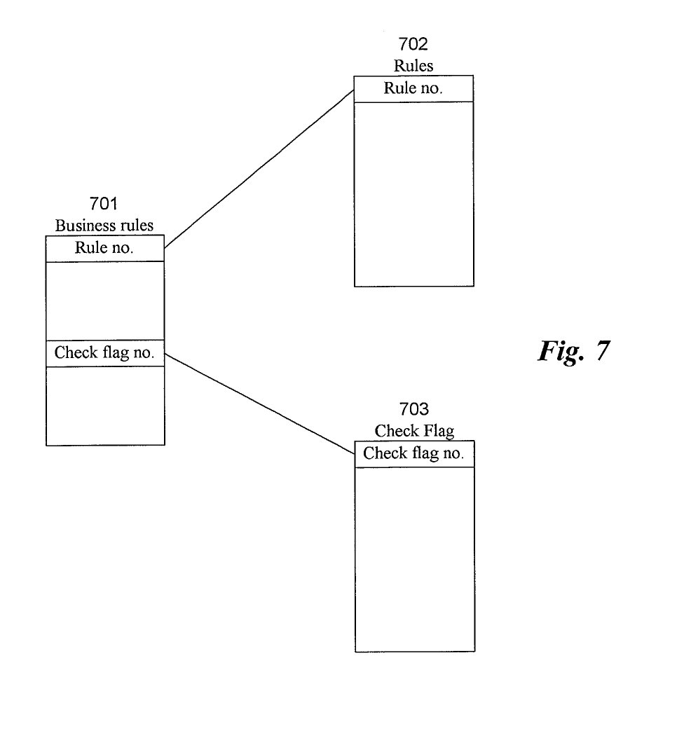

FIG. 7 is a block diagram illustrating the tables of the business rules database in one embodiment.

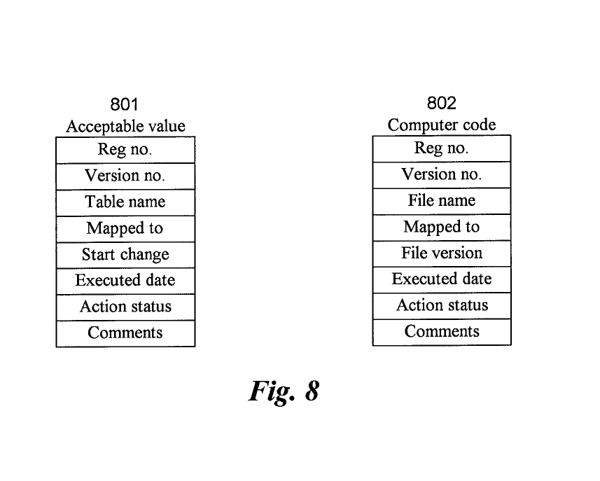

FIG. 8 is a block diagram illustrating the tables of acceptable values database into one embodiment.

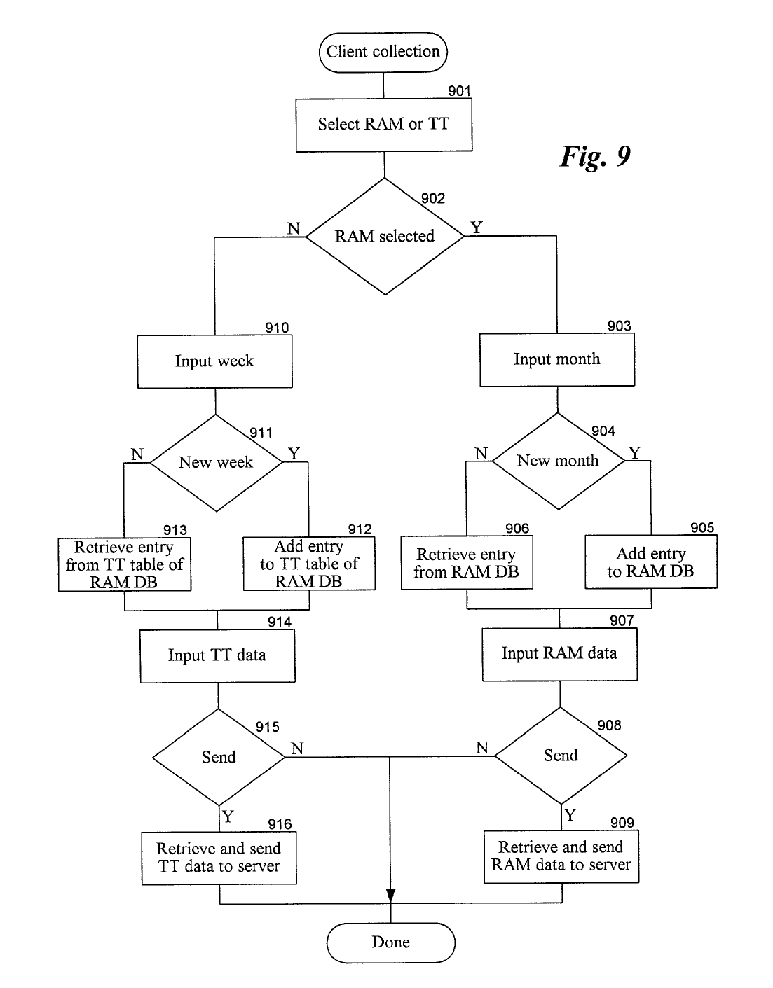

FIG. 9 is a flow diagram illustrating the process of the collection component in one embodiment.

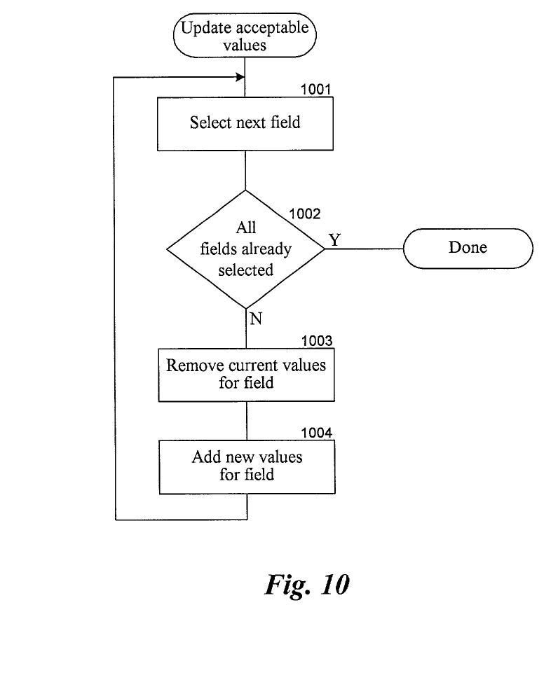

FIG. 10 is a flow diagram illustrating the processing of the update acceptable values component of a client computer in one embodiment.

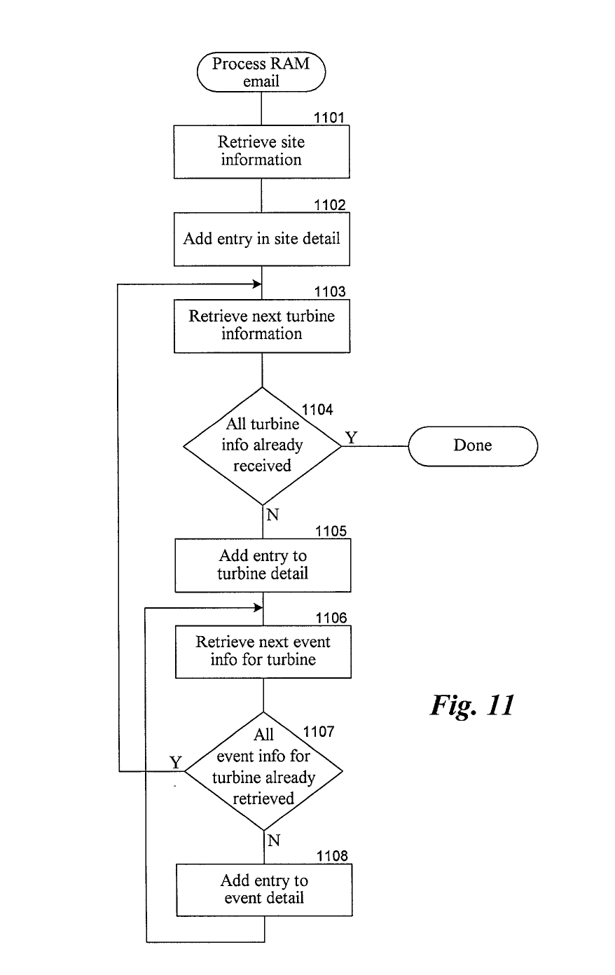

FIG. 11 is a flow diagram of the process RAM electronic mail data component of the server computer in one embodiment.

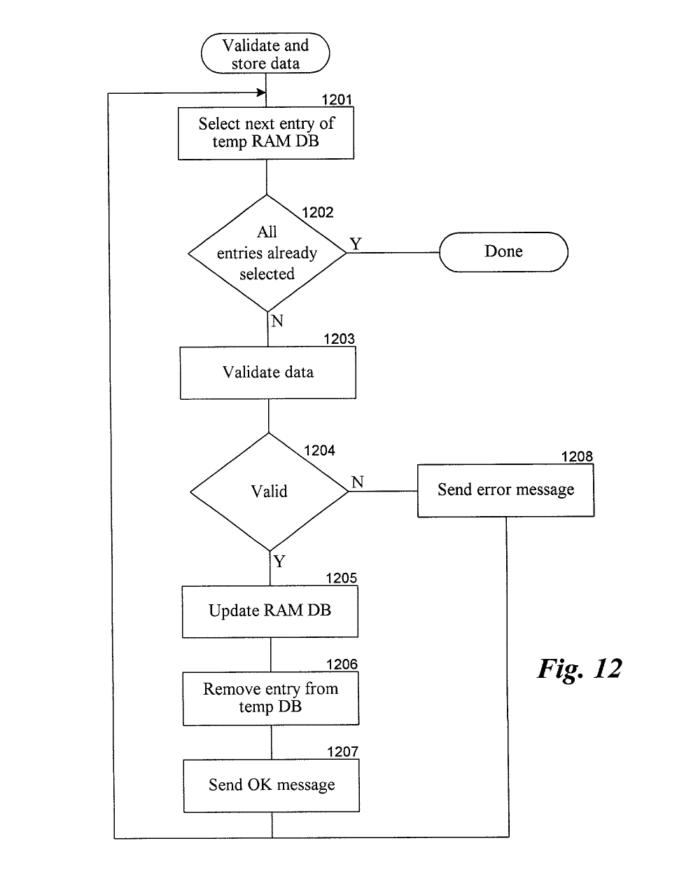

FIG. 12 is a flow diagram illustrating the processing of the validate and store RAM data component in one embodiment.

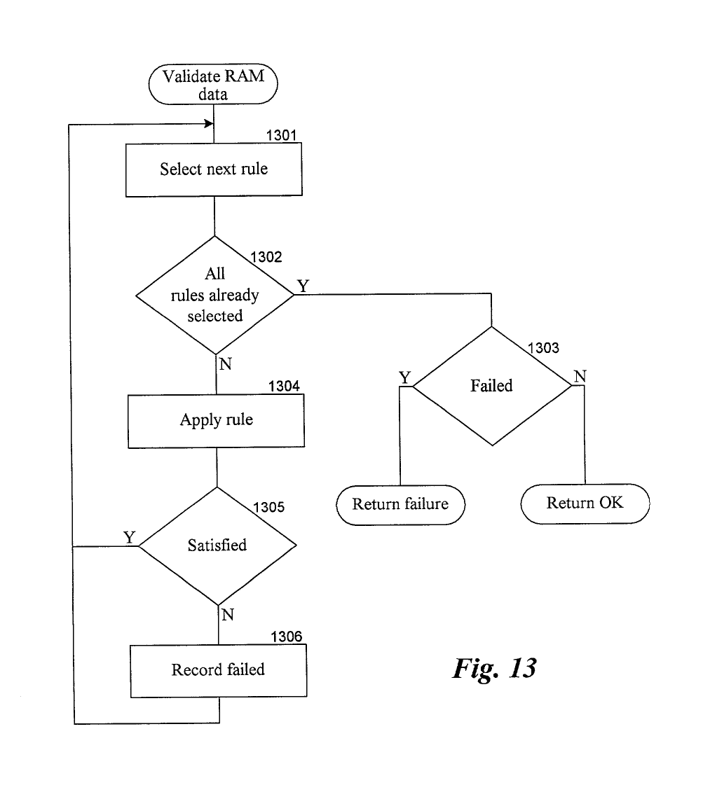

FIG. 13 is a flow diagram of the validate RAM data routine in one embodiment.

### DETAILED DESCRIPTION

A method and system for collecting RAM data from distributed locations is provided. In one embodiment, the collection system includes a client-side component and a server-side component. Each plant from which RAM data is collected has a client computer that runs the client-side component. The maintenance organization has a server computer that runs the server-side component. A user, such as an employee of the plant or a representative of the maintenance organization, collects the RAM data at the plant on periodic basis. This RAM data can be collected in a variety of ways. For example, some equipment may provide display devices that output various measurements, such as number of units processed or hours of operation. The user can manually collect this information from these devices. The client-side component includes a collection component that provides various display pages for the entry of RAM data. After a user collects the RAM data, the user inputs the data using the collection component. Periodically, the client-side component transmits the collected RAM data to the server computer. In one embodiment, the collection system sends the RAM data from the client computers to the server computer via electronic mail messages. The use of electronic mail messages when communicating with plants in countries that are not fully developed is typically more reliable, faster, and cheaper than other forms of communications that may require higher bandwidth. For example, high-speed Internet access is not available in many remote locations. When the server-side component receives the RAM data, it validates the RAM data and, if valid, automatically stores the RAM data in a database. If the RAM data is invalid, then the server-side component sends an error message via electronic mail to the sending client-side component. The user of the client-side component can then correct the error and re-send the RAM data via electronic mail.

The collection system, in one embodiment, includes an update mechanism for updating components of the client-side component and data used by those components via electronic mail. One approach to distributing such updates would be to send a CD-ROM with the update information to each remote location. Such an approach is expensive, time-consuming and requires the users' involvement to effect the updating, which is error prone. The sending of updates via electronic mail avoids these problems. The collection system sends computer code for new and replacement components and updates for various data entry related lists. To minimize data entry errors, the client-side component may provide a user with a list of acceptable values when entering a certain type data. The list of acceptable values may be displayed as drop-down lists associated with a data entry field. These lists of acceptable values quickly become outdated, for example, as new options become available. When updated lists of acceptable values or when new or updated computer code need to be distributed to the client computers, the update mechanism generates an electronic mail message containing instructions for updating the list of acceptable values and computer code. This electronic mail message is then sent to each client computer. When a client computer receives the electronic mail message, it updates its lists and computer code in accordance with the message.

In one embodiment, the collection system collects high-level performance data on a periodic basis (e.g., weekly). The client-side component collects the high-level performance data and sends it to the server-side component via electronic mail. The server-side component stores the high-level performance data for each plant in a database. The high-level performance data may indicate the expected performance and the actual performance of various equipment or of a plant. The collection system may display the high-level performance data using a “ticker tape” metaphor. In particular, the collection system may display an area in which the names of the plants scroll from right to left. The collection system may display adjacent to the plant names a symbol that indicates whether the equipment at the plant is performing worse than expected, as expected, or better than expected. The symbols may be an up arrow to indicate better-than-expected performance, a down arrow to indicate worse-than-expected performance, and a horizontal line to indicate as-expected performance. The symbols may also be displayed in colors such as red, yellow, and green to indicate worse-than-expected performance, as-expected performance, and better-than-expected performance.

FIG. 1 illustrates a display page of the client-side component for collecting information relating to a power plant with one or more turbines. Display page 100 includes overall plant information area 101 and turbine information area 104. The plant information area includes various fields for entry of plant information, such as the name of the facility field 102 and the type of plant field 103. Table 1 contains a description of plant information that may be collected.

TABLE 1
Plant Information

| Field | Characteristics | Description |
|---|---|---|
| Facility | Mandatory, List of | Name of the plant |
| | Values, User Entered | |
| User Name | Mandatory, system | The user Name will default to the |
| | generated or user Entered | userid of the user of the computer. |
| Plant Type | Mandatory, Drop-Down | This field will operate from a drop- |
| | List of Values, User | down list and the user selects one of the |
| | Selected | values. The user cannot add values to |
| | | this list. This drop-down list contains |
| | | the following values: |

| | | |
|---|---|---|
| | | A Simple Cycle |
| | | B Regenerative Cycle |
| | | G Combine Cycle |
| | | H Heat Recovery/Cogeneration |
| | | (instead of CoGen) |
| | | N Nuclear |
| | | Z Undefined |
| Total Plant Rated | Not Mandatory | |
| Output | | |
| Plant Rated Heat Rate | Not Mandatory | |
| Average Heat Rate | Not Mandatory | |

The turbine information area contains fields for entry of turbine-related data and may be displayed by selecting the turbine tab 112. The turbine information may include serial number field 105, manufacture identifier field 106, turbine size field 107, and counter information area 108. The counter information area may include hours of operation field 105, number of starts field 110, and number of trips field 111 of the turbine. Table 2 contains a description of turbine information that may be collected.

TABLE 2
Turbine Information

| Field | Characteristics | Description |
|---|---|---|
| Turbine Serial Number | Mandatory, List of Values, | This is either a Gas or Steam |
| | User Entered | Turbine Serial Number or a |
| | | Generator Serial Number |
| MFR | Mandatory, Drop-Down List of | List of Values: |
| | Values, User Selected | Pratt & Whitney |
| | | Westinghouse |
| | | EGT |
| | | PGT |
| | | Boilers Only |
| | | Siemens |
| | | GE |
| | | ABB |
| Turbine Frame Size | Mandatory, Drop-Down List of | This value drives the values of |
| | Values, User Selected | Turbine Model |
| Turbine Model | Mandatory, Drop-Down List of | This value drives the values of |
| | Values, User Selected | Turbine Design |
| Turbine Design | Mandatory, Drop-Down List of | |
| | Values, User Selected | |
| Turbine Available Hours | Not Mandatory, User Entered | Minimum Value: 0 |
| (AH) | | Maximum Value: 744 |
| | | (31 days × 24 hrs/day) |
| Turbine Available | Not Mandatory, User Entered | Minimum Value: 0 |
| Generation (MWh) | | Maximum Value: None. |
| Turbine Forced Outage | Not Mandatory, User Entered | Minimum Value: 0 |
| Hours (FOH) | | Maximum Value: 744 |
| | | (31 days × 24 hrs/day) |
| Turbine Forced Outage | Not Mandatory, User Entered | Minimum Value: 0 |
| Generation Loss (MWh) | | Maximum Value: None |
| Planned Outage Hours | Not Mandatory, User Entered | Minimum Value: 0 |
| (FOH) | | Maximum Value: 744 |
| | | (31 days × 24 hrs/day) |
| Dispatch/Reserver Hrs | Not Mandatory, User Entered | Minimum Value: 0 |
| | | Maximum Value: 744 |
| | | (31 days × 24 hrs/day) |
| Administrative Outages | Not Mandatory, User Entered | Minimum Value: 0 |
| (AOH) | | Maximum Value: 744 |
| | | (31 days × 24 hrs/day) |
| Turbine Equivalent Unit | Not Mandatory, User Entered | Minimum Value: 0 |
| Derated Hours (EUNDH) | | Maximum Value: None. |
| Turbine Derated | Not Mandatory, User Entered | Minimum Value: 0 |
| Generation Loss (DG) | | Maximum Value: None. |
| Total Generating Set | Mandatory, User Entered | Minimum Value: 0 |
| Successful Starts (SS) | | Maximum Value: none |
| Turbine Net Power | Mandatory, User Entered | Minimum Value: 0 |
| Generated (MWh) | | Maximum Value: none |
| Turbine Net Rated | Mandatory, User Entered | Minimum Value: 0 |
| Monthly Capacity (MWh) | | Maximum Value: none |
| Next Scheduled Outage | Mandatory, User Entered | Format: MM/DD/YYYY |
| Date | | |
| Next Scheduled Outage | Mandatory, Drop-Down List of | List of Values: |
| Event | Values, User Selected | Combustion Inspection |
| | | Hot Gas Path Inspection |
| | | Major Inspection |
| | | Minor Inspection |

FIG. 2 illustrates a display page of the client-side component for collecting information relating to events of a turbine. Display page 200 includes plant information area 101 and event information area 201. The event information area includes data entry fields for event-related information. The event information may include start of event field 202, end of event 203, event code field 204, and urgency code field 205. Some of the data entry fields, such as the event code field, may include a drop-down list of possible values. These lists of possible values may be stored in a database and dynamically changed by the update mechanism. For example, as the collection of information for new types of events can be supported, the collection system may update the list of possible values for the event code. Table 3 contains a description of event information that may be collected.

TABLE 3
Event Information

| Field | Characteristics | Description |
|---|---|---|
| Turbine Serial Number | Mandatory, associates with the | |
| | serial number on the Turbine | |
| | Tab, not allow to enter | |
| Start Date and Time | Mandatory, User Entered | The user enters the date (mm/dd/yyyy) and |
| | | time (hh:mm:ss) of the start of this particular |
| | | event. The system will not require the user to |
| | | enter seconds. If no seconds are entered, the |
| | | system will default to “00” in the seconds' |
| | | position. The user will actually select the |
| | | date from a pop-up calendar. |
| End Date and Time | Mandatory, User Entered | The user enters the date (mm/dd/yyyy) and |
| | | time (hh:mm:ss) of the end of this particular |
| | | event. The system will not require the user to |
| | | enter seconds. If no seconds are entered, the |
| | | system will default to “00” in the seconds' |
| | | position. The user will actually select the |
| | | date from a pop-up calendar. |
| Event Duration | Calculated field, calculation is | This field determines the difference (in hours) |
| | done by the program | between the Start and End date/times and |
| | | displays this to help the user in double- |
| | | checking the information prior to submitting. |
| | | Note: zero not allowed if there is an event. |
| Report Date | System generated, not allow to | This field is set by the internal clock of the |
| | change | computer that the end user is using. There is |
| | | no validation on this field other than a correct |
| | | date/time. The format will be mm-dd-yyyy |
| | | hh:mm:ss. |
| Event Code | Mandatory, Drop-Down List | This field determines what type of event this |
| | of Values, User Selected | is. Attention: |

Trips are FOA, FOM, FS, and NC, Trip
Events enabled when one of these
selected
The Event Code drives Urgency. If you
select FOA, FOM, FU, FS, MU, then you
can select an Urgency Code
List of Values:

| | | |
|---|---|---|
| Event Code | Description | Type |

| | |
|---|---|
| FOA | Forced Outage - Automatic Trip |
| FOM | Forced Outage - Manual Trip |
| FS | Failure to Start - Trip |
| FU | Forced Unavailability |
| MS | Maintenance - Scheduled |
| MU | Maintenance - Unscheduled |
| CM | Concurrent Maintenance |
| NC | Non-Curtailing Event - Trip |
| DR | Derating |

| Urgency Code | Mandatory, Drop-Down List | List of Values: | |
|---|---|---|---|
| | of Values, User Selected | Urgency Code | Description |
| | | 0 | Not Applicable or Failure to |
| | | | Start |
| | | 1 | Immediate Shutdown |
| | | | Requirement |
| | | 2 | Must Shut Down <6 Hours |
| | | 3 | Must Shut Down this Week |
| | | 4 | Can Delay Beyond the |
| | | | Weekend |
| Site Event Log | Mandatory, User Entered | It is assumed that this field will just be a | |
| Number | | text field with no validation, capable of | |
| | | accepting alphanumerics. Length: 50 | |
| | | characters | |
| Source of Data | | linked to operating tab | |
| Keywords Description | Mandatory | This field was described as defaulting to | |
| | | the “first line of Description or free text”. | |
| | | Length: 255 characters | |
| Percent Capacity Loss | | if not de-rating from Event Code default to | |
| | | 100% | |
| MW Loss | | if not de-rating from Event Code then unit | |
| | | rated capacity | |
| MWh Lost | | calculated and displayed and modified | |
| | | * Related for FOA, FOM, FS, FU, MS | |
| | | and MU, these are 100% and <MW | |
| | | Rating * Outrage Hours >. For DR, you | |
| | | can either enter the percent MW lost | |
| | | while still operating (and calculate the | |
| | | MWh Lost) or vice versa. | |
| Fired Hours | | counter reading at start of event-fill in | |
| | | * Fired hours counter reading at time of | |
| | | outage. | |
| Fired Starts | | * Fired hours counter reading at time of | |
| | | outage. | |
| Generic Problem Alert | Check Box, Not Required | Boolean selection “YES/NO” for user to | |
| | | select | |
| | | For this event, the user can indicate that | |
| | | this is a generic problem that all other | |
| | | similar units may have. This is just a flag | |
| | | stored in this event record for this turbine | |
| | | for this facility. | |
| Description of Event | Free-form Text, Required | | |
| Major System | Mandatory, Drop-Down List | Which drives the value of System Code | |
| | of Values, User Selected | List of Values: | |
| | | Major System | Description |
| | | CF | Condensation/Feedwater |
| | | GN | Generator - Gas Turbine |
| | | GT | Gas Turbine |
| | | HR | Heat Recovery Steam |
| | | | Generator |
| | | SE | Station BOP |
| | | SE1 | Block BOP |
| | | SE2 | Dispatch Group BOP |
| | | SN | Generator - Steam |
| | | | Turbine |
| | | ST | Steam Turbine |
| | | Please refer to the lookup table in: | |
| | | EPRI.mdb | |
| System Code | Mandatory, Drop-Down List of | Which drives the value of Component | |
| | Values, User Selected | Group | |
| | | List of Values: | |
| | | System Code | Description |
| | | CO | Condensate System |
| | | FW | Feedwater System |
| | | AA | Atomizing Air |
| | | AD | Accessory Drive |
| | | AI | Air Inlet |

| Component Group | Mandatory, Drop-Down List | Which drives the value of Component | |
|---|---|---|---|
| | of Values, User Selected | Code | |
| | | List of Values: | |
| | | Component Group | Description |
| | | CN | Containers |
| | | EP | Electric Power - Pumps |
| | | EV | Electric Power Values |
| | | FL | Fluid |

| Component Code | Mandatory, Drop-Down List | The Component Code does not drive the | |
|---|---|---|---|
| | of Values, User Selected | Failure Code, or any other field | |
| | | List of Values: | |
| | | Component Code | Description |
| | | 001 | |
| | | 001 | |
| | | 003 | |
| Failure Category | Mandatory, Drop-Down List | List of values: | |
| | of Values, User Selected | Controls Issue - Sequencing, Constants, | |
| | | Tuning | |
| | | Device/Instrument Issue - Assy, Design, | |
| | | Calibration | |
| | | Planned - Overspeed test | |
| | | Operations Issue - Procedural Training | |
| | | Installation Issue - Assy, Worksmanship | |
| | | Equipment Issue - Design, Worksmanship | |
| | | Commissioning Issue - BOP testing, | |
| | | Maintenance Activities | |
| Fuel Operation On | Mandatory, Drop-Down | List of Values: | |
| | List of Values, User Selected | Natural Gas | |
| | | LNG Liquid Natural Gas | |
| | | Syn Gas | |
| | | Gas - Other | |
| | | Naphtha | |
| | | Light Distillate | |
| | | Heavy Distillate | |
| | | Light Crude/Residual | |
| | | Heavy Crude/Residual | |
| Failure Mode | Mandatory, Drop-Down | List of Values: | |
| | List of Values, User Selected | Failure Mode | Description |
| | | 101 | Blue Blush |
| | | 102 | Cracked |
| | | 103 | Distortion |
| Action Code | Mandatory, Drop-Down | List of Values: | |
| | List of Values, User Selected | Action Code | Description |
| | | A01 | Balanced |
| | | A02 | Bored |
| | | . | . |
| | | | . |
| | | . | . |
| | | A99 | |

FIG. 3 illustrates a display page of the client-side component for collecting high-level performance information. Display page 300 includes a reporting period area 301, a performance parameters area 304, and a send report button 307. The high-level performance information is also referred to as “ticker tape” data. The reporting period area includes a site (e.g., facility or plant) name field 302 and a week ending field 303. The performance parameters area includes a customer expected plant total field 305 and a customer actual plant total field 306. After the user inputs the high-level performance information, the user selects the send report button to transmit the high-level performance information to the server computer.

FIG. 4 illustrates a display of high-level performance data. Display page 400 includes a ticker tape area 401. The ticker tape area includes the names of various sites that may automatically scroll from the right to the left. Each site name includes an indication of the performance of that site. For example, site name 401 includes an up arrow to indicate that the site is performing better than expected, site name 403 includes a down arrow to indicate that site is performing worse than expected, and site name 404 includes a horizontal line to indicate that the site is performing as expected. In addition, the site names and adjacent symbols may be displayed in various colors to indicate the performance of the site. The site names that scroll may include all sites serviced by the maintenance organization or subsets of those sites as indicated by a site selection query (e.g., all the sites of a single customer).

FIG. 5 is a block diagram illustrating the components of the collection system in one embodiment. The client computers 510 may be connected to the server computer 520 via a communications link 530. The computers may include a central processing unit, memory, input devices (e.g., keyboard and pointing devices), output devices (e.g., display devices), and storage devices (e.g., disk drives). The memory and storage devices are computer-readable media that may contain instructions that implement the collection system. In addition, the data structures and message structures include requests and responses that may be stored or transmitted via a data transmission medium such as a signal on the communications link. The client computers include a collection component 511, a process error component 512, an update acceptable values component 513, an electronic mail component 514, a RAM database 515, and an acceptable values database 516. The collection component controls the collection of RAM data and high-level performance data. The process error component receives error messages from the server computer and coordinates the correcting of the errors. The update acceptable values component receives indications of revised lists of acceptable values and revised computer code for the components and coordinates the updating. The electronic mail component controls the sending of the electronic mail generated by the collection component and the receiving of electronic mail received from the server computer. The RAM database contains the RAM data and high-level performance data collected by the collection component before the data is sent to the server computer. The acceptable values database contains the lists of acceptable values for the various data entry fields. The collection component uses the acceptable values database to generated the drop-down lists that are displayed during the collection process. The server computer includes a electronic mail component 521, a process electronic mail data component 522, a validate and store data component 523, a sent acceptable values component 524, a display high-level performance data component 525, a temporary RAM database 526, a RAM database 527, and business rules 528.The electronic mail component coordinates the receiving and sending of electronic mail messages. The process electronic mail data component controls the store of the RAM data in received from the plants in the temporary RAM database. The validate and store data components validates the data stored in the temporary RAM database and, if valid, store the data in the RAM database. The send acceptable values component controls the sending of lists of acceptable values as indicated by the acceptable values database to the client computers. The send high-level performance data component controls the display of the ticker tape. The business rules database contains the validate rules for the RAM data.

FIG. 6 is a block diagram illustrating the structure of the RAM-related databases. The RAM database of the client computers and the temporary RAM database and RAM database of the server computer may have the same structure. The RAM database includes a site header table 601, a high-level performance data table 602, a site detail table 603, a turbine header table 604, a turbine detail table 605, and an event detail table 606.The site header table contains an entry for each site and contains overall static information for that site (e.g., site name). The site detail table contains an entry for each reporting period of each site and contains information relating to that reporting period (e.g., reporting month). The turbine header table contains an entry for each turbine at each site and contains overall static information for that turbine (e.g., serial number). The turbine detail table contains an entry for each turbine at each site for each reporting period and contains the information collected about that turbine for that reporting period (e.g., number a starts). The event detail contains entry for each event associated with each entry of the turbine detail table and contains information relating to the event (e.g., duration). The high-level performance data table contains an entry for each reporting period for each site and contains the high-level performance data for that reporting period (e.g., fuel consumption). Tables 4-9 list the fields of the tables of the RAM database in one embodiment.

TABLE 4
SITE_HEADER

SITEID
FACILITYNAME
PLANTID
CONTRACT_INDEX
REGION_INDEX
DUTY_INDEX

TABLE 5
SITE_DETAIL

SITE_DETAIL_ID
SITENAME
RPTDATE
USERNAME
PLANTTYPE
REPORTMONTH
STEAMTURBINENO
GENERATORNO
PLANTRATEDOUTPUT
PLANTRATEDHEATRATE
PLANTAVGHEATRATE

TABLE 6
TURBINE_HEADER

SITENAME
SERIALNO
TURBINESIZE
MFR
TURBINEDESIGN
TURBINEMODEL

TABLE 7
TURBINE_DETAIL_ID

SITE_DETAIL_ID
SERIALNO
AVAILHRS
AVAILGEN
FORCEDOUTHRS
FORCEDOUTGENLOSS
PLANNEDOUTHRS
DISPRESHRS
ADMINOUTAGE
DERATEDHRS
DERATEDGENLOSS
SUCCESSATTEMPTS
SUCCESSSTARTS
NETPOWERGENERATED
NETRATEDMONTHCAP
GASHRS
LIQUIDHRS
CRUDE
RESIDUAL
OTHER
BASEHRS
PEAKHRS
HRS
STARTS
TRIPS
DAYSINSRVC
NEXTOUTDATE
NEXTOUTEVENT

TABLE 8
EVENT_DETAIL

SITE_DETAIL_ID
EVENTID
SERIALNO
STARTDATE
ENDDATE
DURATION
RPTDATE
EVENTCODE
URGENCYCODE
SITEEVENTLOG
SOURCEOFDATA
DESCRIPTION
CAPLOSS
MWLOSS
MWSUSPECT
MWHLOST
MWHSUSPECT
FIREDHRS
FIREDSTARTS
PROBALERT
EVENTDESC
MAJORSYSTEMCODE
SYSTEMCODE
GROUPCODE
COMPONENTDESCRIPTION
INCIDENTCODE
ACTIONCODE
TRIPNUMBER
FAILURECATEGORY
ALARMDROPNUMBER
ALARMDROPNAME
SPEED
LOADNUMBER
FUELOPERATIONON
ROOTCAUSEEVENT
CORRECTIVEACTION

TABLE 9
TBL_TT_TICKERTAPE

TT_INDEXNO
TT_SITEID
TT_REPORTDATE
TT_PLANTTOTAL_CUST_EXP
TT_PLANTTOTAL_CUST_ACT
TT_EQUIP_EXP
TT_EQUIP_ACT
TT_STARTS_ATM
TT_STARTS_ACT
TT_FUEL_CON_GAS
TT_FUEL_GAS_UNIT
TT_FUEL_CON_NAPTHA
TT_FUEL_NAPTHA_UNIT
TT_FUEL_CON_DIST
TT_FUEL_DIST_UNIT
TT_COMMENTS
TT_USERID

FIG. 7 is a block diagram illustrating the tables of the business rules database in one embodiment. The business rules are used by the server-side component to determine whether the RAM data collected from a client computer is valid. The business rules database includes a business rules table 701, a rules table 702, and a check flag table 703.The business rules table contains an entry for each rule that is to be applied to the collected RAM data. The rules table contains an entry for each rule along with a description of that rule. The check flag table contains an entry for the various types of checks to be performed by a rule. For example, a check flag table may contain one entry indicating that the check should be to determine whether the value of a certain field is in a certain table or within a certain percentage of reference value. Tables 10-12 contain a description of the fields of the tables of business rules database.

TABLE 10
Business Rules Table

| | | Default | |
|---|---|---|---|
| Data Input Name | Mandatory | Value | Description |
| SN_RULE_NO | True | | Maps to the rules table |
| SN_CHECK_FIELD_NAME | True | | Check field name for which |
| | | | business rule should apply |
| SN_OPERATOR | | | Operator on which rule works |
| SN_PERCENT_OPERATOR | | | % Operator |
| SN_REF_TABLE | | | Table name from which data is |
| | | | required to validate |
| SN_REF_FIELD | | | |
| SN_CHECK_VALUE | | | Business Standard value |
| SN_CHECK_FLAG_NO | True | | Maps to check flag table |
| SN_MANDATORY | True | | Tells the compulsion of validity |
| | | | of this rule. |
| SN_LAST_UPD_USER | True | | Name of the user who |
| | | | created/updated the table |
| SN_LAST_UPD_DATE | True | | Date and time when the Created/ |
| | | | updated the table |

TABLE 11
Rules Table

| | | Default | |
|---|---|---|---|
| Data Input Name | Mandatory | Value | Description |
| SN_RULE_NO | True | | System generated |
| SN_RULE_DESC | True | | Description of Business rule |

TABLE 12
Check Flag Table

| | | Default | |
|---|---|---|---|
| Data Input Name | Mandatory | Value | Description |
| SN_CHECK_{—} | True | | 1 to 4 |
| FLAG_NO | | | |
| SN_CHECK_{—} | True | | Description of Business rule |
| FLAG_DESC | | | 1. Check SN_REF_FIELD |
| | | | 2. Check SN_REF_TABLE |
| | | | 3. Check both |
| | | | 4. Check either field or table |

FIG. 8 is a block diagram illustrating the tables of acceptable values database in one embodiment. The acceptable value database includes an acceptable value table 801 and a computer code table 802. The acceptable value table contains an entry for each list of acceptable values used by the collection system. The table name field identifies a table that contains the list of acceptable values. The computer code table contains an entry for each component of the collection component of the client-side component. The file name field indicates the name of the file that contains the executable code for that component. Periodically, the server-side component sends the entries of the acceptable value table and the computer code table to the client computers. In one embodiment, these tables may contain only data related to revisions that need to be made to the client computers.

FIG. 9 is a flow diagram illustrating the processing of the collection component in one embodiment. The collection component controls the collecting of RAM data and of high-level performance data and sending of the collected data to the server computer. In block 901, the component inputs a user selection to input RAM data or high-level performance data. In decision block 902, if RAM data was selected, then the component continues at block 903, else the component continues at block 910.In block 903, the component inputs the month that the RAM data is to cover. In decision block 904, if the data for the month has not been collected before, then the component continues at block 905, else the component continues at block 906. In block 906, the component adds an entry to the RAM database (i.e., in the site detail table) for the month. In block 906, the component retrieves the entry from the RAM database for the month. In block 907, the component inputs the RAM data. The component may initialize the RAM data entry fields with values previously entered for that month. In decision block 908, if the user selects the send button, then the component continues at block 909, else the component completes. In block 909, the component sends the RAM data that has been collected for that month to the server computer and then completes. In block 910, the component inputs the week that the high-level performance data is to cover. In decision block 911, if the data for that week has not been collected before, then the component continues at block 912, else the component continues at block 913.In block 912, the component adds an entry to the high-level performance data table of the RAM database. In block 913, the component retrieves the entry from the high-level performance data table of the RAM database for the week. In block 914, the component inputs the high-level performance data. The component may initialize the high-level performance data entry fields with data previously collected for that week. In decision block 915, if the user selects the send button, then the component continues at block 916, else the component completes. In block 916, the component sends the collected high-level performance data for that week to the server computer and then completes

FIG. 10 is a flow diagram illustrating the processing of the update acceptable values component of a client computer in one embodiment. In block 1001, the component selects the next field whose list is to be updated. In decision block 1002, if all the fields have already been selected, then the component completes, else the component continues at block 1003.In block 1003, the component clears the list of current values for the field. In block 1004, the component adds the list of new values for the field to the acceptable value database. The component then loops to block 1001 to select the next field.

FIG. 11 is a flow diagram of the process RAM electronic mail data component of the server computer in one embodiment. This component parses an electronic mail message containing RAM data and stores the data in the temporary RAM database. Table 13 contains an example of an electronic mail message with RAM data.

TABLE 13

| SITE INFORMATION: | |
|---|---|
| FacilityName: | East Coast Power |
| Report_date: | 03/30/2000 5:37:15 PM |
| Username: | jiangma |
| Plant_type: | CoGen |
| TURBINE INFORMATION: | |
| Turbine_Serial_no: | 270T356 |
| Turbine_Design: | 11 |
| Turbine_FrameSize: | LM5000 |
| Turbine_MFR: | Pratt & Whitney |
| Turbine_Model: | EA |
| NextOutDate: | 03/30/2000 5:37:33 PM |
| NextOutEvent: | Trial 2 |
| EVENT INFORMATION: | |
| EventID: | 2 |
| StartDate: | 03/29/2000 5:33:10 PM |
| EndDate: | 03/30/2000 5:41:10 PM |
| Duration: | 1448 |
| RptDate: | 03/30/2000 5:41:39 PM |
| EventCode: | DR |
| UrgencyCode: | 1 |

In block 1101, the component retrieves the site information from the electronic mail message. In block 1102, the component adds an entry to the site detail table corresponding to the reporting period represented by the site information. In blocks 1103-1108, the component loops processing the information for each turbine and for each event of the turbine represented in the electronic mail message. In block 1103, the component retrieves the information for the next turbine. In block 1104, if information for all the turbines has already been retrieved, then the component completes, else the component continues at block 1105.In block 1105, the component adds an entry to the turbine detail table corresponding to the retrieved information. In blocks 1106-1108, the component loops processing information for each event related to that turbine. In block 1106, the component retrieves the next event information for that turbine. In decision block 1107, if all the event information for that turbine has already been retrieved, then the component loops to block 1103 to select the information for the next turbine, else the component continues at block 1108. In block 1108, the component adds an entry to the event detail table corresponding to the retrieved event and then loops to block 1106 to retrieve the next event information.

FIG. 12 is a flow diagram illustrating the processing of the validate and store RAM data component in one embodiment. This component retrieves the data from the temporary database, validates the data, and stores the valid data in the RAM database. In block 1201, the component retrieves the next entry in the site table of the temporary RAM database. If all the entries have already been selected, then the component completes, else the component continues at block 1203. In block 1203, the component validates the data relating to the selected entry (e.g., the data in the turbine detail table and the event detail table). In decision block 1204, if the data is valid, then the component continues at block 1205, else the component continues at block 1208. In block 1205, the component updates the RAM database with the data for the selected entry. In block 1206, the component removes the data relating to the selected entry from the temporary RAM database. In block 1207, the component sends an okay message to the client computer and loops to block 1201 to select the next entry. In block 1208, the component sends an error message to the client computer and loops to block 1201 to select the next entry.

FIG. 13 is a flow diagram of the validate RAM data routine in one embodiment. This routine is invoked by the validate and store RAM data component. This routine loops selecting each of the business rules and applying the rules to the RAM data. In block 1301, the routine selects the next rule. In decision block 1302, if all the rules have already been selected, then the routine continues at block 1303, else the routine continues at block 1304. In decision block 1303, if at least one of the rules failed, then the routine returns a failure indication, else the routine returns a success indication. In block 1304, the routine applies the selected rule to the data. In decision block 1305, if the selected rule is satisfied, then the routine loops to block 1301 to select the next rule, else the routine continues at block 1306. In block 1306, the routine records the failure and loops to block 1301 to select the next rule.

From the foregoing, it will be appreciated that although embodiments of the collection system have been described for purposes of illustration, various modifications may be made without deviating from the spirit and scope of the invention. For example, the collection system may not allow a user to enter RAM data unless RAM data for a previous collection period is entered. When the collection system is initially installed, it may require that the user enter RAM data for the previous collection period. Also, a single client computer may collect data for multiple facilities or for a single facility, and each facility may have one or more turbines. Accordingly, the invention is not limited except by the appended claims.

1. A computer system for collecting RAM data from distributed locations, comprising:
a plurality of RAM collection clients that provides a user interface for collecting RAM data for a turbine, the RAM data including event information relating to the turbine, and that sends the collected RAM data to a RAM collection server via electronic mail; and
a RAM collection server that receives RAM data sent via electronic mail from RAM collection clients, that validates the received RAM data, that sends a message to the RAM collection clients indicating whether the received RAM data is valid, and that stores valid RAM data in a RAM database.

2. The computer system of claim 1 wherein a RAM collection client receives from the RAM collection server a list of acceptable values for RAM data and wherein the RAM collection client uses the list of acceptable values to filter values entered by a user.

3. The computer system of claim 1 wherein a RAM collection client collects data covering sequential periods and does not allow collecting of RAM data for a period unless RAM data for the prior period was collected.

4. The computer system of claim 1 wherein a RAM collection client stores collected RAM data locally until a user indicates to send the collected RAM data.

5. The computer system of claim 1 wherein a RAM collection client reports when a electronic mail message is received from the RAM collection server indicating that the received RAM data is not valid.

6. The computer system of claim 1 wherein the RAM collection server validates the received RAM data using business rules stored in a table.

7. A method in a computer system for collecting RAM data, the method comprising:
for each of a plurality of sites,
receiving via an electronic mail message RAM data for that site, the RAM data covering a period;
determining whether the received RAM data is valid;
when the received RAM data is determined to be not valid, sending an electronic mail message to the site indicating that the RAM data is not valid; and
storing valid RAM data in a database.

8. The method of claim 7 wherein the determining of whether RAM data is valid includes retrieving rules indicating whether data is valid from a table of business rules.

9. The method of claim 7 including when the received RAM data is determined to be valid, sending an electronic mail message to the site indicating that the RAM data is valid.

10. The method of claim 7 wherein the received electronic mail messages include information describing the site, describing turbines at the site, and describing events associated with each turbine.

11. The method of claim 7 wherein the electronic mail message sent to the site indicates that the RAM data is not valid includes the RAM data.

12. A method in a computer system for displaying performance of turbines of a plurality of sites, the method including displaying a ticker tape scrolling on a display device, the ticker tape including a name of each site and a symbol adjacent to the name to indicate performance of the turbines at the site.

13. The method of claim 12 wherein an upward pointing symbol indicates better-than-expected performance and a downward pointing symbol indicates worse-than-expected performance.

14. The method of claim 13 wherein a horizontally oriented symbol indicates as-expected performance.

15. The method of claim 12 wherein a green symbol indicates better-than-expected performance, a yellow symbol indicates as-expected performance, and a red symbol indicates worse-than-expected performance.

16. The method of claim 12 wherein performance of each turbine at a site is indicated individually.

17. The method of claim 12 wherein the indicated performance is relative to contractually guaranteed level of performance.

18. The method of claim 12 wherein the performance relates to megawatt hours.

19. A computer-based method for controlling entry of values for fields at a computer, the method comprising:
inputting a value for a field, the input value being in a list of acceptable values for the field;
receiving from a remote computer a new list of acceptable values for the field; and
inputting a value for the field, the input value being in the new list of acceptable values
whereby the acceptable values are dynamically changed when the new list is received from the remote computer.

20. The method of claim 19 wherein the new list of acceptable values is received via an electronic mail message sent from the remote computer.

21. The method of claim 19 wherein the inputting of a value includes displaying a list of acceptable values.

22. The method of claim 19 wherein the field relates to RAM data of a turbine.

23. The method of claim 19 wherein the computer is located at facility that includes a turbine.
